(19) United States
(12) Patent Application Publication
(10) Pub. No.: US 2026/0330941 A1
(43) Pub. Date: Oct. 22, 2026

(54) SECURITY ASSISTANCE SYSTEM, SECURITY ASSISTANCE METHOD, AND RECORDING MEDIUM

(71) Applicant: NEC Corporation, Minato-ku, Tokyo (JP)

(72) Inventors: Koki SAKAI, Tokyo (JP); Yoko TANAKA, Tokyo (JP); Nozomi MATSUMOTO, Tokyo (JP)

(73) Assignee: NEC Corporation, Minato-ku, Tokyo (JP)

(21) Appl. No.: 19/110,536

(22) PCT Filed: Oct. 13, 2022
(86) PCT No.: PCT/JP2022/038232

§ 371 Date: Mar. 11, 2025

(51) Int. Cl. G08B 13/196

(52) U.S. Cl. CPC G08B 13/19613; G08B 13/19608

(57) ABSTRACT

A security assistance system according to the present invention includes a memory configured to store instructions; and one or more processors configured to execute the instructions to: receive an abnormality notification from a security system of a facility set as a security target; select a camera disposed at a road nearest to the facility; acquire an image captured by the camera; and transmit the acquired image to a predetermined terminal.

### TECHNICAL FIELD

The present disclosure relates to a security assistance system, a security assistance method, and a recording medium.

### BACKGROUND ART

PTL 1 discloses an example of an abnormality notification system capable of suppressing dispatch of a security entity due to erroneous reporting by a fire sensor, an intrusion sensor, and a monitoring camera abnormality detector disposed in a building such as a house, a bookstore, a factory, a warehouse, and a parking lot. According to PTL 1, this abnormality notification system performs determination using a building device using a personal computer of a security target facility to transmit an image obtained by imaging an abnormal situation to a terminal device such as a mobile phone managed by an administrator when it is determined that notification is necessary. The administrator refers to the received image, determines whether a final notification is necessary, and then transmits the image to a security entity such as a security company to request a dispatch.

PTL 2 discloses an example of a personal security system using a mobile terminal. According to PTL 2, the security system includes a function of selecting the nearest security terminal based on position information received from a mobile terminal, and a function of outputting a map representing the position information received from the mobile terminal and an image from the selected security terminal.

### CITATION LIST

### Patent Literature

PTL 1: JP 2002-183850 A

PTL 2: JP 2005-316578 A

### SUMMARY OF INVENTION

### Technical Problem

In the abnormality notification system of PTL 1, an image transmitted to a security entity such as a security company is an image captured by an abnormality detector disposed in a building as a security target. Therefore, there is a problem that confirmation of the situation around the facility as a security target and the presence of a suspicious person or a suspicious vehicle is delayed.

In the method of PTL 2, there is a possibility that an image from an appropriate security terminal can be obtained, but there is a problem that the user is required to carry the mobile terminal and turn on the security mode.

An object of the present disclosure is to provide a security assistance system, a security assistance method, and a program recording medium that can facilitate grasping of a situation around a facility set as a security target.

### Solution to Problem

According to a first aspect, there is provided a security assistance system including a reception means for receiving an abnormality notification from a security system of a facility set as a security target, an acquisition means for selecting a camera disposed at a road nearest to the facility, and acquiring an image captured by the camera, and a transmission means for transmitting the acquired image to a predetermined terminal.

According to a second aspect, there is provided a security assistance method including receiving an abnormality notification from a security system of a facility set as a security target, selecting a camera disposed at a road nearest to the facility, and acquiring an image captured by the camera, and transmitting the acquired image to a predetermined terminal.

According to a third aspect, there is provided a recording medium recording a program for causing a computer to execute the steps of receiving an abnormality notification from a security system of a facility set as a security target, selecting a camera disposed at a road nearest to the facility, and acquiring an image captured by the camera, and transmitting the acquired image to a predetermined terminal.

### Advantageous Effects of Invention

According to the present disclosure, there are provided a security assistance system, a security assistance method, and a program recording medium that can facilitate grasping of a situation around a facility set as a security target.

### BRIEF DESCRIPTION OF DRAWINGS

FIG. 1 is a diagram illustrating a configuration of an example embodiment of the present disclosure.

FIG. 2 is a flowchart illustrating an operation of an example embodiment of the present disclosure.

FIG. 3 is a diagram for describing an operation of an example embodiment of the present disclosure.

FIG. 4 is a block diagram illustrating the configuration of the security assistance system of the first example embodiment of the present disclosure.

FIG. 5 is a diagram for describing camera disposition information held by the security assistance system according to the first example embodiment of the present disclosure.

FIG. 6 is a flowchart illustrating the operation of the security assistance system of the first example embodiment of the present disclosure.

FIG. 7 is a block diagram illustrating the configuration of the security assistance system of the second example embodiment of the present disclosure.

FIG. 8 is a flowchart illustrating the operation of the security assistance system of the second example embodiment of the present disclosure.

FIG. 9 is a diagram for describing the operation of the security assistance system of the second example embodiment of the present disclosure.

FIG. 10 is a block diagram illustrating the configuration of the security assistance system of the third example embodiment of the present disclosure.

FIG. 11 is a flowchart illustrating the operation of the security assistance system of the third example embodiment of the present disclosure.

FIG. 12 is a diagram for describing the operation of the security assistance system of the third example embodiment of the present disclosure.

FIG. 13 is a block diagram illustrating the configuration of the security assistance system of the fourth example embodiment of the present disclosure.

FIG. 14 is a diagram for describing the operation of the security assistance system of the fourth example embodiment of the present disclosure.

FIG. 15 is a diagram for describing the operation of the security assistance system of the fourth example embodiment of the present disclosure.

FIG. 16 is a block diagram illustrating the configuration of the security assistance system of the fifth example embodiment of the present disclosure.

FIG. 17 is a flowchart illustrating the operation of the security assistance system of the fifth example embodiment of the present disclosure.

FIG. 18 is a diagram for describing the operation of the security assistance system of the fifth example embodiment of the present disclosure.

FIG. 19 is a diagram illustrating the configuration of a computer that can function as the security assistance system of the present disclosure.

### EXAMPLE EMBODIMENT

First, an outline of an example embodiment of the present disclosure will be described with reference to the drawings. The reference numerals in the drawings attached to this outline are attached to respective elements for convenience as an example for assisting understanding, and are not intended to limit the present disclosure to the illustrated aspects. Connection lines between blocks in the drawings and the like referred to in the following description include both bidirectional and unidirectional. The unidirectional arrow schematically indicates a flow of a main signal (data), and does not exclude bidirectionality. The program is executed via a computer device, and the computer device includes, for example, a processor, a storage device, an input device, a communication interface, and a display device as necessary. The computer device is configured to be able to communicate with equipment (including a computer) inside or outside the device via a communication interface regardless of wired or wireless. Although there are ports and interfaces at connection points of input to output of each block in the drawing, illustration thereof is omitted.

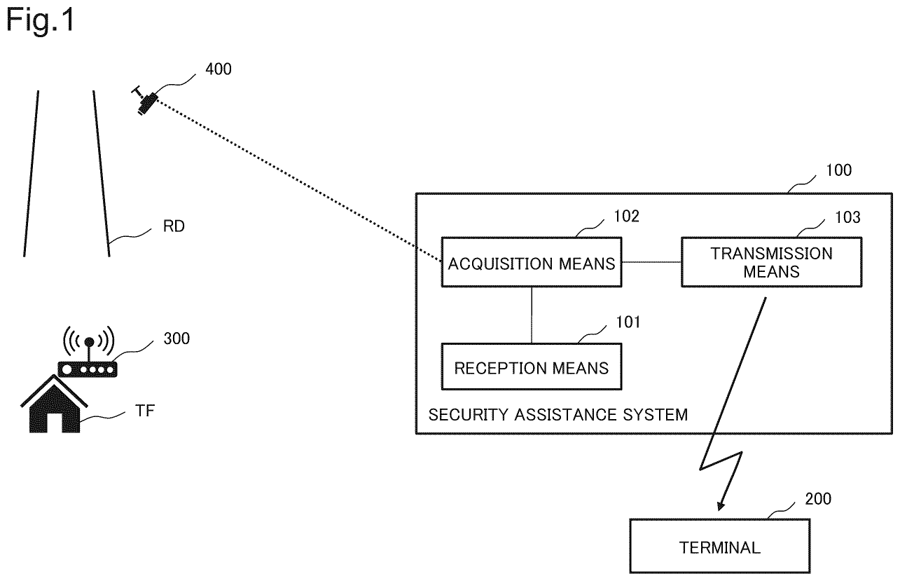

In an example embodiment thereof, as illustrated in FIG. 1, the present disclosure can be achieved by a security assistance system 100 including a reception means 101, an acquisition means 102, and a transmission means 103.

The reception means 101 receives the abnormality notification from a security system 300 of a facility TF set as a security target. As the security system 300, a system having a function of notifying a predetermined terminal or the like at the time of abnormality detection provided by a private security company, a building material manufacturer, or the like can be used.

The acquisition means 102 selects a camera 400 disposed at a road RD nearest to the facility TF, and acquires an image captured by the camera 400. As a method of selecting the camera 400 by the acquisition means 102, a method of selecting the nearest camera 400 based on the position of the facility TF, a method of selecting the camera 400 associated with the facility TF in advance, or the like can be used. The method of acquiring the image captured by the camera 400 selected by the acquisition means 102 is not limited to the mode in which the acquisition means 102 directly requests the camera 400 to transmit the image. For example, in a case where the camera 400 transmits an image to a predetermined transmission destination (control center, live-camera image publishing server, etc.), the acquisition means 102 can acquire an image of the camera 400 selected from these transmission destinations. The nearest road RD is not limited to a road adjacent to the facility TF. A road further adjacent to an adjacent road may be included. In addition, an area (for example, a parking lot) adjacent to the facility TF may be used instead of the road.

The transmission means 103 transmits the acquired image to a predetermined terminal 200. The terminal 200 may be, for example, a control terminal of a security company, or a mobile terminal or an in-vehicle terminal of a person in charge of a security company set in advance.

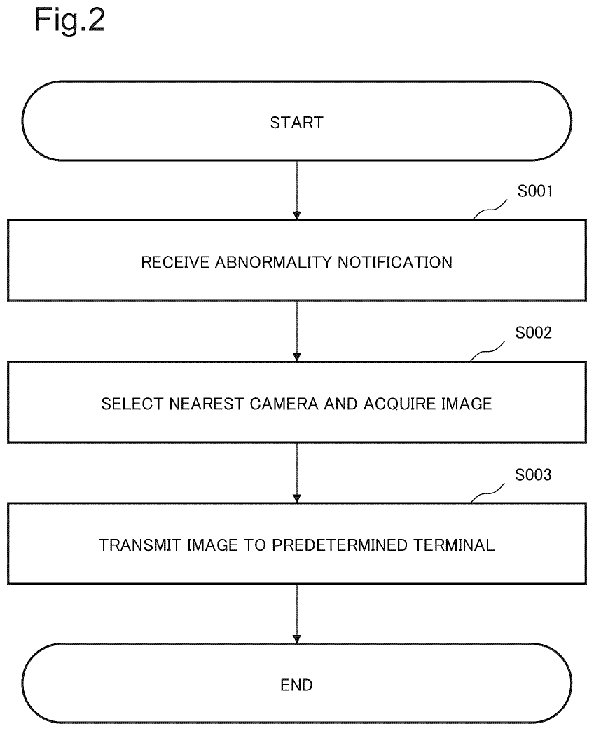

FIG. 2 is a flowchart illustrating a security assistance method used in the security assistance system 100. As illustrated in FIG. 2, when receiving the abnormality notification from the security system 300 (step S001), the security assistance system 100 configured as described above selects the camera 400 disposed at the road nearest to the facility TF. Further, the security assistance system 100 acquires an image captured by the selected camera 400 (step S002). The security assistance system 100 transmits the acquired image to the predetermined terminal 200 (step S003).

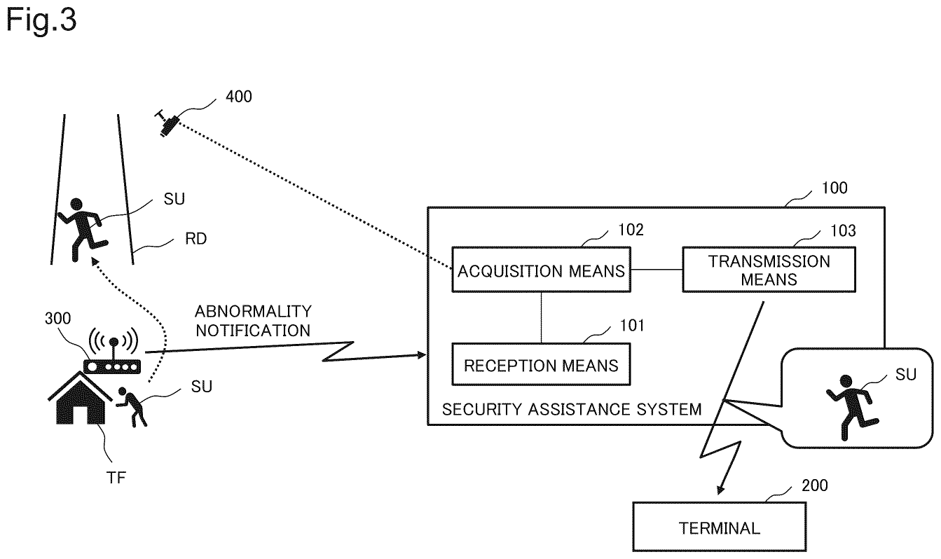

FIG. 3 is a diagram for describing an operation of the present example embodiment. As illustrated in FIG. 3, when any abnormality occurs in the facility TF set as the security target, the security system 300 transmits an abnormality notification. When receiving the abnormality notification, the security assistance system 100 selects the nearest camera 400 and acquires an image. The security assistance system 100 transmits the acquired image to the terminal 200. The image acquired by the security assistance system 100 may be an image captured by a plurality of cameras 400 in addition to one camera 400 as illustrated in FIG. 3. The image acquired by the security assistance system 100 may be continuous images or a moving image.

In the example of FIG. 3, a suspicious person SU who has intruded into the facility TF appears in the image of the camera 400, but it is also conceivable that the suspicious person SU does not appear in the image acquired from the camera 400. Even in such a case, by transmitting the image to the terminal 200, it is possible to cause a security control person or the like to consider the possibility that the suspicious person SU is hiding in the facility TF or the possibility that the suspicious person SU has escaped using another route.

According to the security assistance system 100 operating as described above, it is possible to easily grasp the situation around the facility TF set as the security target.

### First Example Embodiment

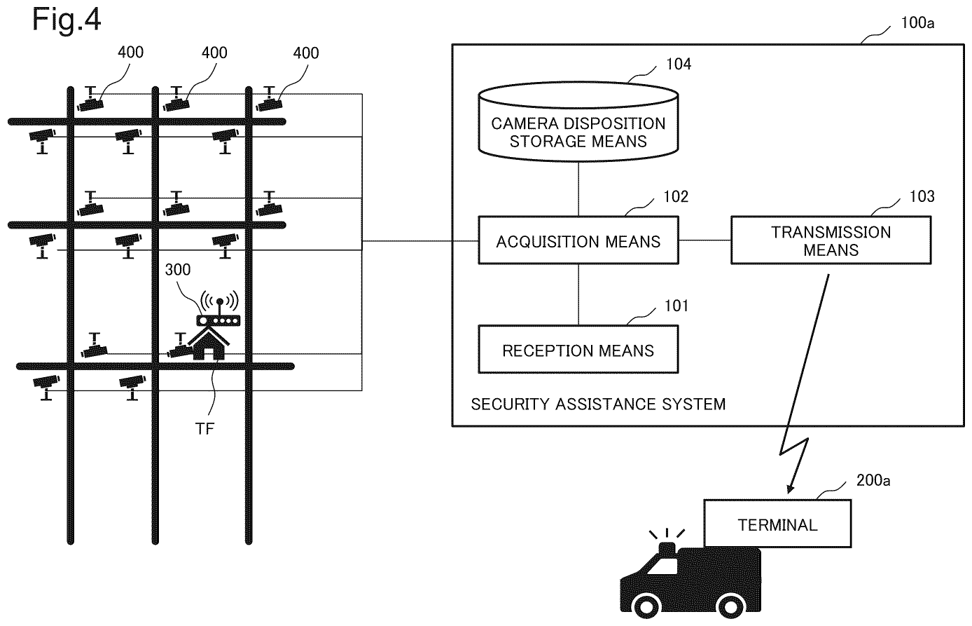

Next, a first example embodiment in which a search function of a suspicious person, a suspicious vehicle, or the like is added to a security assistance system will be described in detail with reference to the drawings. FIG. 4 is a block diagram illustrating the configuration of a security assistance system 100a of the first example embodiment of the present disclosure. Referring to FIG. 4, the security assistance system 100a including the reception means 101, the acquisition means 102, the transmission means 103, and a camera disposition storage means 104 is illustrated. In the present example embodiment, the description will be given on the assumption that the camera 400 is a camera installed at an intersection of a road or the like, and the facility TF as a security target is located at one corner of an area where the camera 400 is installed at a main intersection.

When receiving the abnormality notification from the security system 300 of the facility TF, the reception means 101 transmits the position information and the like of the facility TF included in the abnormality notification to the acquisition means 102, and instructs the acquisition means to start the image acquisition operation.

The acquisition means 102 selects the camera 400 having a high possibility of capturing a person or a vehicle who has visited the facility TF, and acquires an image captured by the camera 400. Specifically, the acquisition means 102 selects the camera 400 based on the position information about the facility TF received from the reception means 101 and the camera disposition information (the position and orientation of the camera disposed around the facility TF) held in the camera disposition storage means 104. As an example of a method of selecting the camera 400 having a high possibility of capturing a person or a vehicle who has visited the facility TF, a method of selecting one or more cameras directed in the direction of the facility TF can be used.

Further, the acquisition means 102 selects an image in which a person or a vehicle appears from the acquired images, and transmits the image to the transmission means. In this manner, the security assistance system 100a is provided with a function of searching for a suspicious person or a suspicious vehicle.

The transmission means 103 transmits the series of images acquired by the acquisition means 102 to a terminal 200a of a person in charge of security of the facility TF. In the present example embodiment, the transmission means 103 transmits an image to a terminal 200a of a person in charge of security who is heading to the facility TF or a terminal 200a of a predetermined vehicle (for example, a patrol car or a security vehicle) patrolling around the facility TF by using a mobile communication network or road-to-vehicle communication.

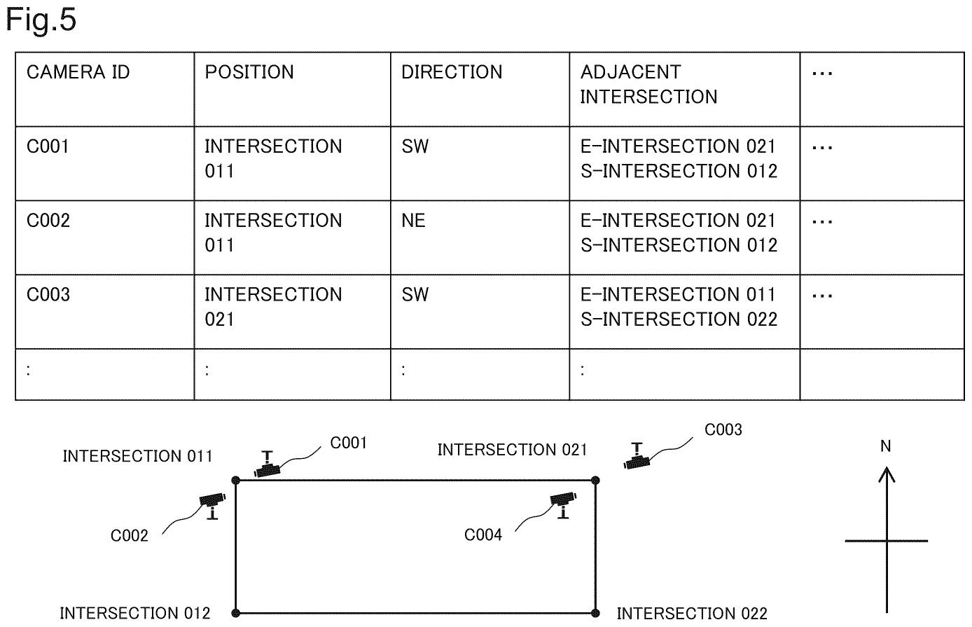

The camera disposition storage means 104 stores camera disposition information for the acquisition means 102 to select the camera 400. FIG. 5 is a diagram for describing an example of the camera disposition information, and as illustrated in the lower part of FIG. 5, it is assumed that there are intersections 011 to 022 and cameras C001 to C004 are disposed at intersections 011 and 021. The upper part of FIG. 5 illustrates the camera disposition information about the cameras C001 to C003. For example, the camera C001 is installed at the intersection 011 and is oriented to the southwest. Based on such information, the acquisition means 102 selects the camera 400 having a high possibility of capturing a person or a vehicle who has visited the facility TF. The information about the adjacent intersection indicates information about the adjacent intersection to be referred to in a case where a person or a vehicle appearing in an image is moving or the image is small. For example, in a case where an image captured by the camera C002 of a person or a vehicle appearing on the east side of the intersection 011 is small, the acquisition means 102 can add a camera installed at the intersection 021, which is an adjacent intersection, to the selection candidates. Although the disposition of the cameras 400 disposed at the intersection is stored in the example of FIG. 5, the camera 400 disposed at a place other than the intersection may be stored in the camera disposition storage means 104 and added to the selection target of the acquisition means 102.

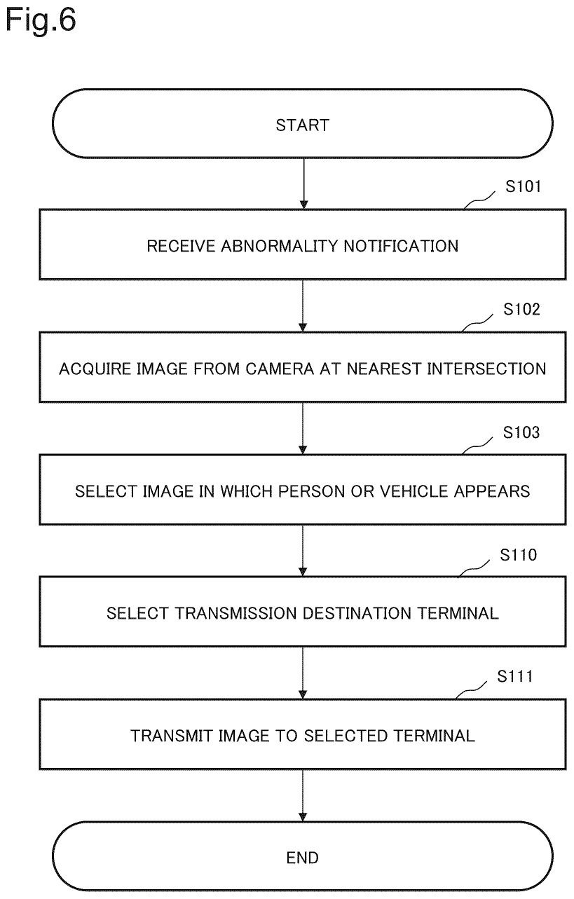

Next, the operation of the present example embodiment will be described in detail with reference to the drawings. FIG. 6 is a flowchart illustrating the operation of the security assistance system 100a of the first example embodiment of the present disclosure. Referring to FIG. 6, when receiving the abnormality notification from the security system 300 of the facility TF (step S101), the security assistance system 100a selects one or more cameras 400 at the intersection nearest to the facility TF and acquires an image captured by the camera 400 (step S102).

Next, the security assistance system 100a selects an image in which a person or a vehicle appears from the acquired images (step S103). In a case where there is no image in which a person or a vehicle appears, or in a case where it is desired to confirm that there is no person or a vehicle, this processing step may be omitted, and the image acquired in step S102 may be selected.

Next, the security assistance system 100a selects the terminal 200a as the transmission destination of the image (step S110). Specifically, the security assistance system 100a selects the terminal 200a of the person in charge of security who is heading to the facility TF.

Finally, the security assistance system 100a transmits the image selected in step S103 to the selected terminal 200a (step S111).

According to the security assistance system 100a operating as described above, it is possible to search for a person or a vehicle around the facility TF captured by the camera at the intersection nearest to the facility TF, and to notify the terminal 200a of the person in charge of security who is heading for the facility TF of the presence of the person or the vehicle.

The person in charge of security who has received such an image can contact related organizations such as the police and prepare equipment on the way to the facility TF. For example, a person in charge of security can transmit information about a person or a vehicle appearing in an image to a related organization such as the police. Even in a case where a person or a vehicle does not appear in the received image, the person in charge of security can consider a possibility that a suspicious person or a suspicious vehicle is hidden, a possibility that the suspicious person or the suspicious vehicle has escaped using another route, a possibility that the security system 300 malfunctions, and the like.

### Second Example Embodiment

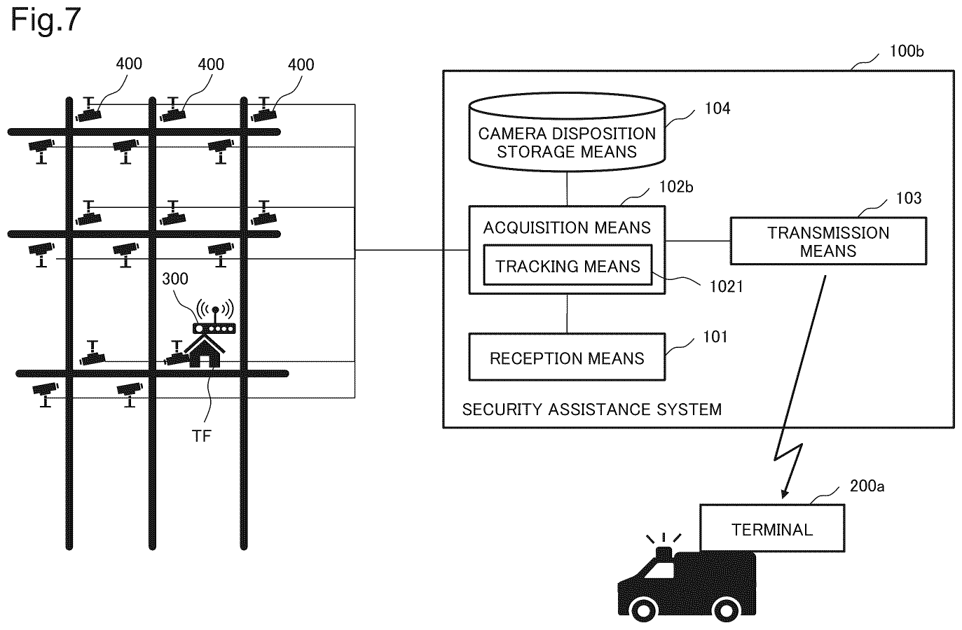

Next, the second example embodiment in which a function of tracking a suspicious person, a suspicious vehicle, or the like is added to the security assistance system will be described in detail with reference to the drawings. FIG. 7 is a block diagram illustrating the configuration of a security assistance system 100b of the second example embodiment of the present disclosure. A difference from the first example embodiment illustrated in FIG. 4 is that a tracking means 1021 is added to an acquisition means 102b of the security assistance system 100b. Since other configurations are similar to those of the first example embodiment, description thereof will be omitted, and differences will be mainly described below.

The tracking means 1021 tracks a person or a vehicle by estimating a traveling direction from a direction or a posture of the person or the vehicle appearing in an image based on the image acquired by the acquisition means 102b and selecting a camera capable of capturing a situation in the traveling direction.

The acquisition means 102b repeats a process of acquiring an image captured by the camera 400 selected by the tracking means 1021 and delivering the image to the tracking means 1021 for a certain period of time.

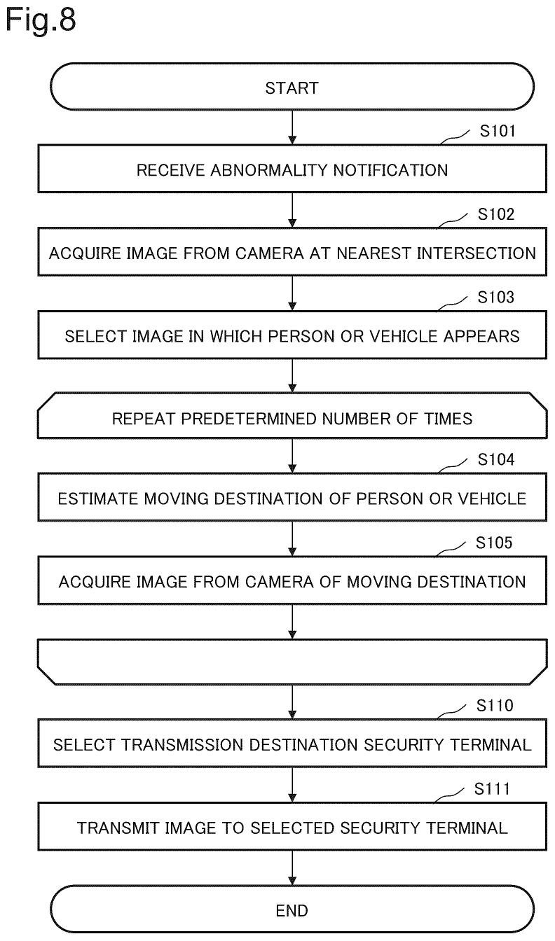

FIG. 8 is a flowchart illustrating the operation of the security assistance system 100b of the second example embodiment of the present disclosure. A difference from the first example embodiment illustrated in FIG. 6 is that a process of estimating a destination of a person or a vehicle appearing in the images in steps S104 to S105 and acquiring an image from the camera 400 at the destination is repeated a predetermined number of times to track the person or the vehicle and acquire the image.

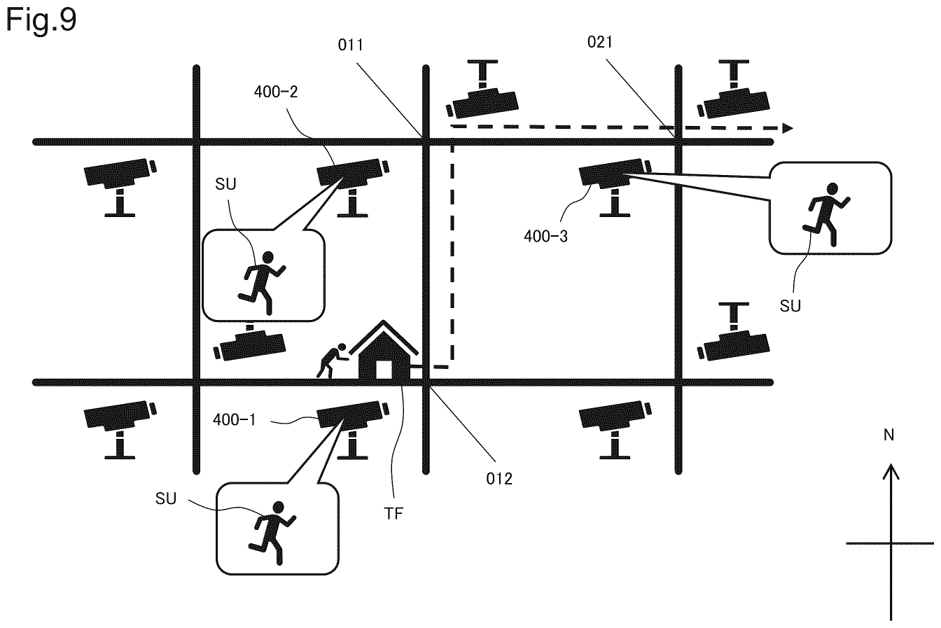

FIG. 9 is a diagram for specifically describing an operation of the security assistance system 100b of the present disclosure. For example, it is assumed that a suspicious person intrudes into the facility TF as a security target, and exits the facility TF to the east, turns left at the intersection 012 to the north, turns right at the intersection 011 to the east, and escapes on a route going straight through the intersection 021 as indicated by a broken line in FIG. 9. In this case, the security assistance system 100b first estimates that the suspicious person SU has turned left at the intersection 012 and moved toward the intersection 011 from the image captured by the camera 400-1. The security assistance system 100b selects a camera 400-2 capable of capturing the intersection 011 and acquires an image. Further, the security assistance system 100b estimates that the suspicious person SU has turned right at the intersection 011 and moved toward the intersection 021 from the image captured by a camera 400-1. The security assistance system 100b selects a camera 400-3 capable of capturing the intersection 021 and acquires an image. By repeating such an operation, the suspicious person SU is tracked and an image is acquired.

By transmitting such a plurality of images to the terminal 200a of the person in charge of security who is heading to the facility TF, it is possible to cause the person in charge of security to take appropriate measures. In the above example, an example of tracking the suspicious person SU is described, but it is also possible to track the suspicious vehicle in a similar procedure.

As described above, according to the present example embodiment, it is possible to notify the terminal 200a of the person in charge of security who is heading to the facility TF of the trend and the destination of the person or the vehicle found around the facility TF.

### Third Example Embodiment

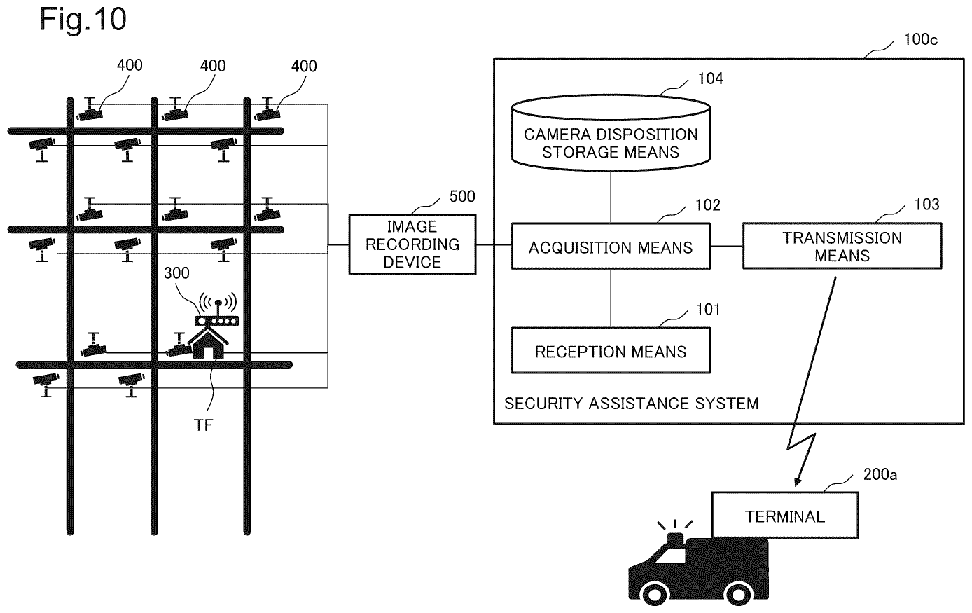

Next, the third example embodiment in which a function of transmitting an image before receiving an abnormality notification is added to the security assistance system will be described in detail with reference to the drawings. FIG. 10 is a block diagram illustrating the configuration of a security assistance system 100c of the third example embodiment of the present disclosure. A difference from the first example embodiment illustrated in FIG. 4 is that an image recording device 500 is disposed between a security assistance system 100c and a camera 400, and the security assistance system 100c can acquire an image from the image recording device 500. Since other configurations are similar to those of the first example embodiment, description thereof will be omitted, and differences will be mainly described below.

The image recording device 500 is a device that stores an image received from the camera 400 for a certain period in association with an ID of the camera or the like. The image recording device 500 may be a dedicated device, or may be a device used for traffic monitoring, traffic violation detection, and the like.

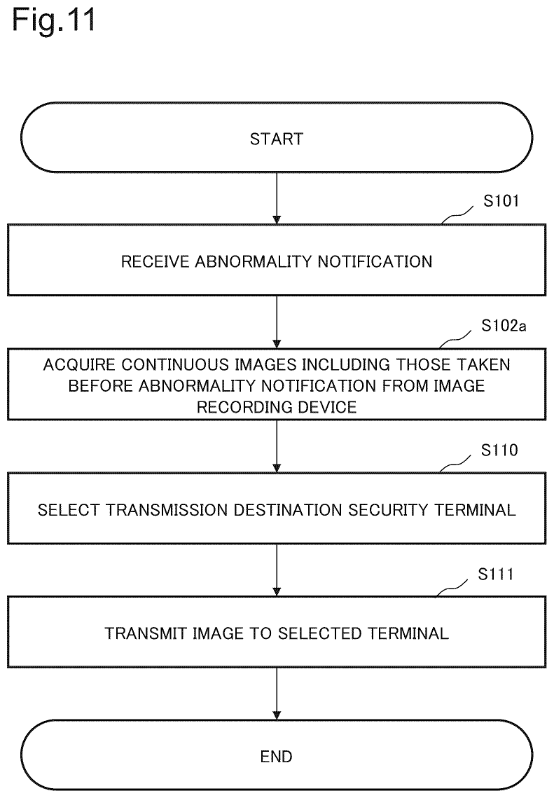

Next, the operation of the present example embodiment will be described in detail with reference to the drawings. FIG. 11 is a flowchart illustrating the operation of the security assistance system 100c of the third example embodiment of the present disclosure. A difference from the first example embodiment illustrated in FIG. 6 is that, in step S102a, the security assistance system 100c acquires an image including a past image a predetermined time before the time when the abnormality notification is received from the image recording device 500. In FIG. 11, processing of selecting an image in which a person or a vehicle is captured is omitted. Other operations are the same as those of the first example embodiment, and thus description thereof is omitted.

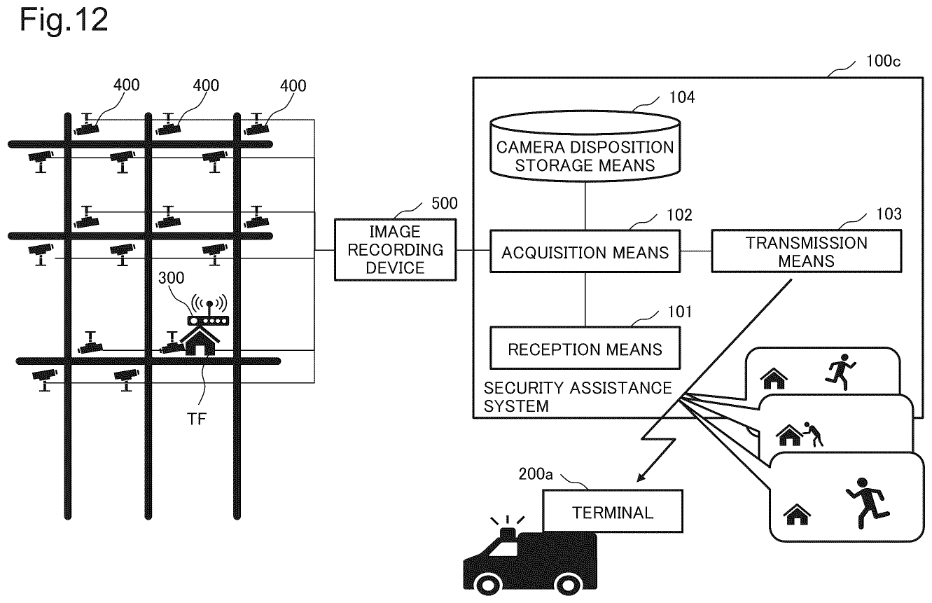

According to the present example embodiment, for example, as illustrated in FIG. 12, it is possible to transmit an image around the facility TF before the abnormality notification is received to the terminal 200a of the person in charge of security. In a particularly desirable form, as illustrated in FIG. 12, it is possible to capture an image of a suspicious person who goes to the facility TF, attempts to intrude, and leaves the facility TF. As in the first example embodiment, it is also conceivable that no person or vehicle appears in the received image. Also in this case, according to the present example embodiment, it is possible to consider a possibility that a suspicious person or a suspicious vehicle is hidden, a possibility that the suspicious person or the suspicious vehicle has escaped using another route, a possibility that the security system 300 malfunctions, and the like.

### Fourth Example Embodiment

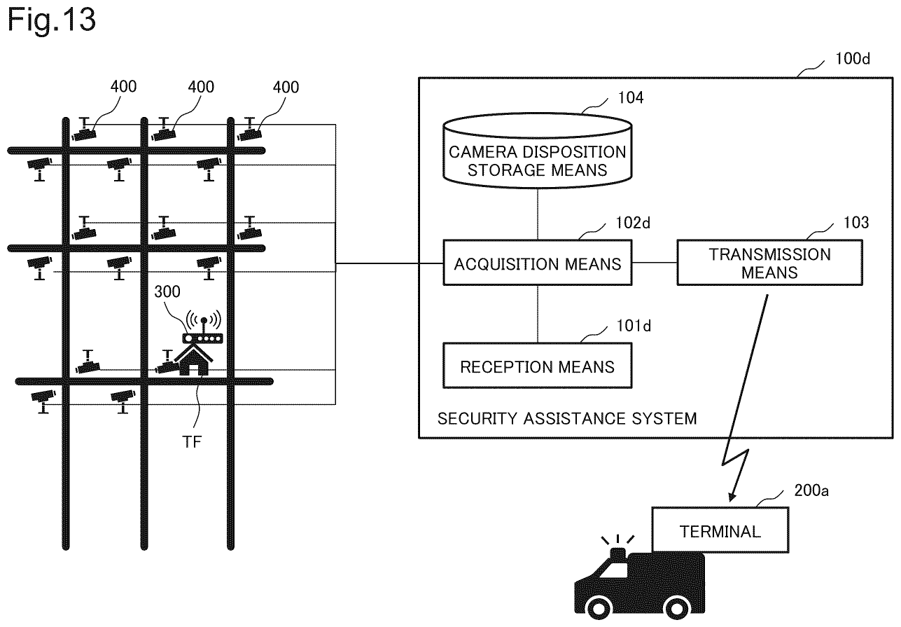

Next, the fourth example embodiment in which a camera selection method is changed according to the content of abnormality notification will be described in detail with reference to the drawings. FIG. 13 is a block diagram illustrating the configuration of a security assistance system 100d of the fourth example embodiment of the present disclosure. The difference from the first example embodiment illustrated in FIG. 4 is the functions of a reception means 101d and an acquisition means 102d of the security assistance system 100d. Since other configurations are similar to those of the first example embodiment, description thereof will be omitted, and differences will be mainly described below.

The security system 300 detects an abnormality of the facility TF including its type and makes notification of the abnormality. In addition to the function of receiving the abnormality notification transmitted from the security system 300 of the facility TF, the reception means 101d has a function of extracting information indicating the type of abnormality included in the abnormality notification and transmitting the information to the acquisition means 102d.

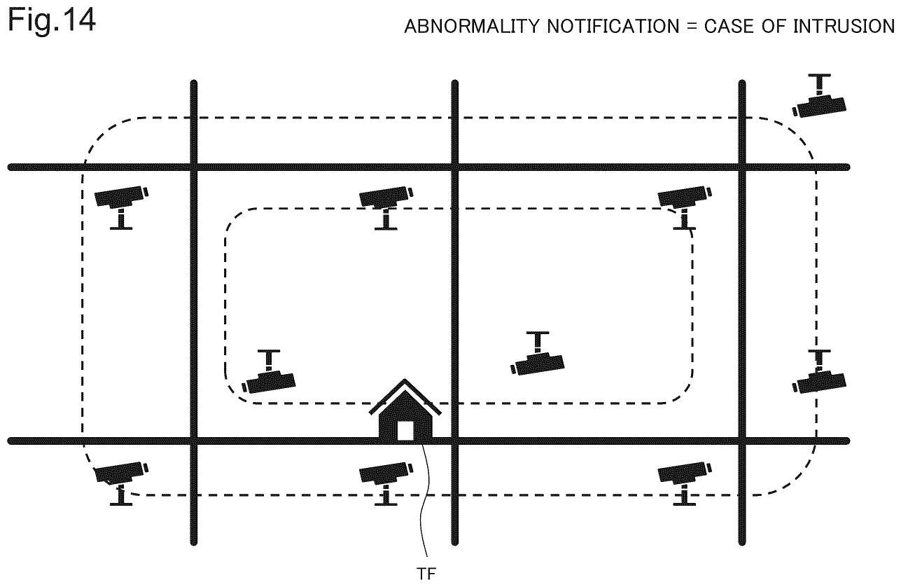

The acquisition means 102d has a function of selecting the camera from which the image is acquired based on the type of abnormality notification. For example, in a case where the abnormality notification includes information indicating that entry into the facility TF has been detected, the acquisition means 102d performs an operation of increasing the number of cameras 400 to be selected. FIG. 14 is a diagram in which a selection range of cameras in a case where information indicating that entry into the facility TF has been detected is included is indicated by a broken line. In this manner, by increasing the range of the cameras 400 that acquire images, it is possible to improve the detection rate of a suspicious person or a suspicious vehicle that has executed or attempted intrusion.

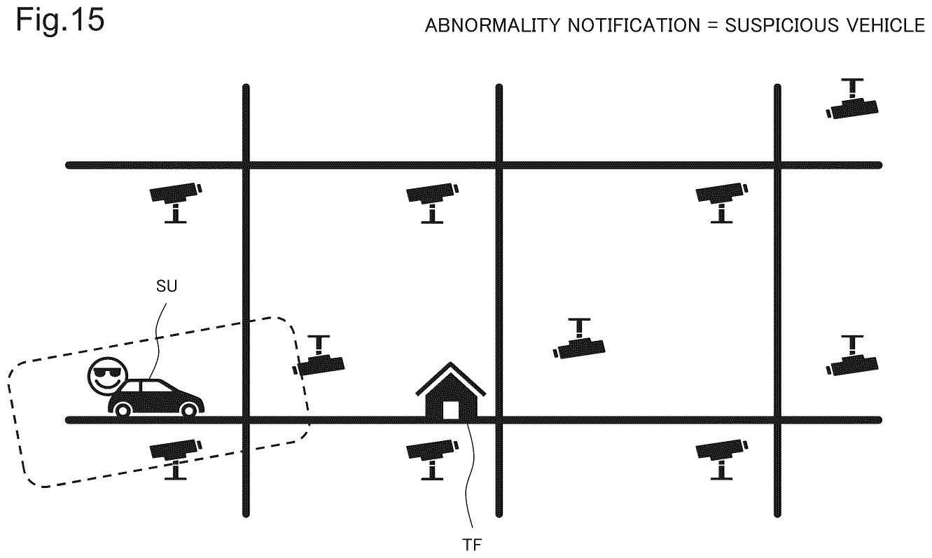

For example, in a case where the abnormality notification includes detection of a suspicious person or a suspicious vehicle staying around the facility TF and position information indicating the position of the suspicious person or the suspicious vehicle, the acquisition means 102d selects a camera capable of grasping the stay situation of the suspicious person or the suspicious vehicle based on the position information included in the abnormality notification. FIG. 15 is a diagram illustrating a camera selection range by a broken line in a case where information indicating that a suspicious person or a suspicious vehicle staying around the facility TF is detected is included. As described above, in a case where it is desired to monitor a suspicious person or a suspicious vehicle staying around the facility TF, the acquisition means 102d performs an operation of narrowing the camera 400 to be selected to a camera around the suspicious person or the suspicious vehicle. In this way, it is not possible to erroneously determine another person or vehicle as a suspicious person or a suspicious vehicle, and it is possible to improve the capture rate of the suspicious person or the suspicious vehicle.

According to the security assistance system 100d operating as described above, it is possible to appropriately change the image to be acquired according to the content of the abnormality generated in the facility TF. In the examples of FIGS. 14 and 15, the case where the intrusion into the facility TF and the stay of the suspicious person or the suspicious vehicle around the facility TF are detected is described. However, the range of the camera to be selected may be changed at the time of receiving other types of abnormality notification. For example, in order to facilitate grasping of the surrounding situation at the time of occurrence of a disaster or the like, the entire area of the surrounding road may be set as an image acquisition target as illustrated in FIG. 14. In a case where the content of the abnormality notification is a failure or the like of internal equipment of the facility TF, control may be performed to suppress acquisition of an image.

### Fifth Example Embodiment

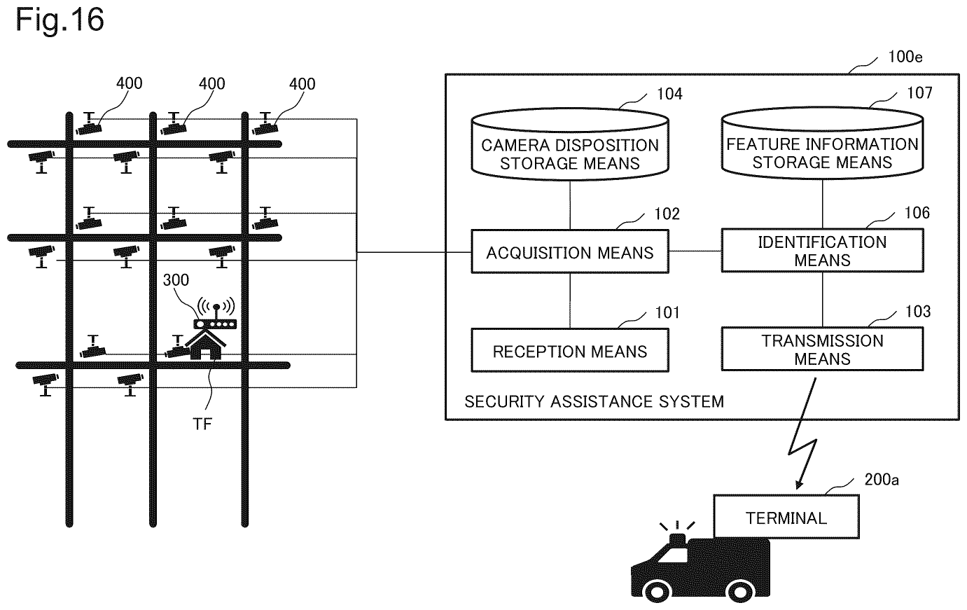

Next, the fifth example embodiment in which a recognition result of a person or a vehicle can be superimposed and displayed on an image to be transmitted to a terminal will be described in detail with reference to the drawings. FIG. 16 is a block diagram illustrating the configuration of a security assistance system 100e of the fifth example embodiment of the present disclosure. A difference from the first example embodiment illustrated in FIG. 4 is that an identification means 106 and a feature information storage means 107 are added to the security assistance system 100e. Since other configurations are similar to those of the first example embodiment, description thereof will be omitted, and differences will be mainly described below.

The feature information storage means 107 stores feature information about the appearance of a person to be identified by the identification means 106 for each facility as a security target. As the person to be identified, a group of persons who has the authority to enter and exit the facility TF (whitelist), a group of persons who should be avoided from entering and exiting the facility TF (blacklist), or the like can be considered. As the feature information, feature information capable of executing authentication using an image, such as feature data for face authentication about the person, is used.

The identification means 106 identifies a person in the image received from the acquisition means 102 by using the feature information stored in the feature information storage means 107. In a case where the identification of the person appearing in the image is successful, the identification means 106 performs a process of superimposing information about the person who has been successfully recognized in the image on the image received from the acquisition means 102.

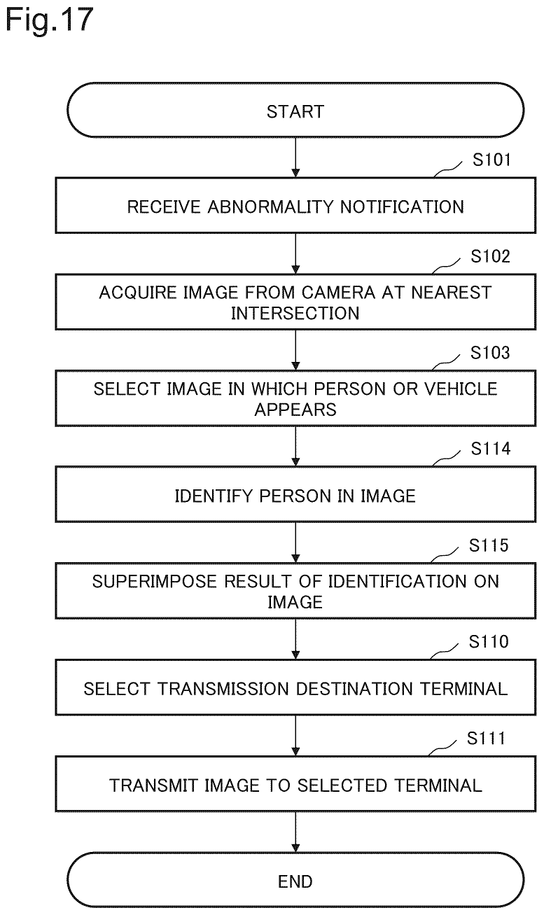

FIG. 17 is a flowchart illustrating the operation of the security assistance system 100e of the fifth example embodiment of the present disclosure. A difference from the first example embodiment illustrated in FIG. 6 is that steps S114 to S115 are added after the image is selected. The security assistance system 100e selects an image in which a person or a vehicle appears from the acquired images (step S103), and then attempts to identify the person appearing in the image (step S114). When the identification of the person appearing in the image is successful, the security assistance system 100e superimposes the result of identification on the image to be transmitted to the transmission means 103 (step S115). In a case where the identification of the person appearing in the image has failed in step S114, information such as “unknown” may be superimposed on the image to be transmitted to the transmission means 103 as the recognition result.

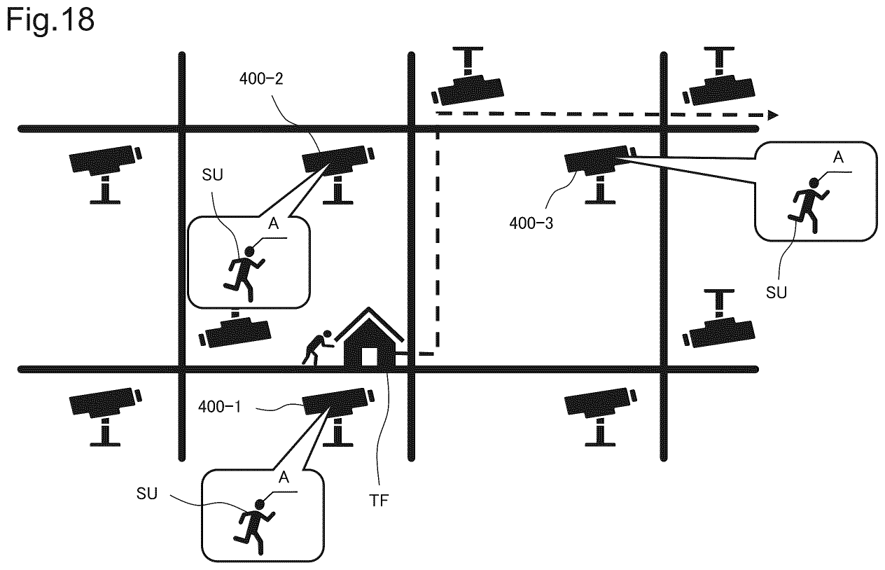

FIG. 18 is a diagram for describing the operation of the security assistance system 100e according to the fifth example embodiment of the present disclosure. As illustrated in FIG. 18, in a case where the person appearing in the image can be identified as A, the security assistance system 100e transmits an image on which the recognition result is superimposed to the terminal 200a.

As described above, according to the present example embodiment, it is possible to transmit information about a person appearing in an acquired image to a person in charge of security who is heading to the facility TF. For example, in a case where the person A is a habitual burglar, the person in charge of security reports to the police at an early stage, so that it is possible to enhance execution of inspection and reinforcement of patrol. For example, in a case where the person A is an employee or a user of the facility TF, the person in charge of security can take a measure such as contacting the employee or the user.

In the above-described example embodiment, it is described that the identification means 106 identifies the person appearing in the image, but the identification means 106 may identify the vehicle. In this case, the feature information storage means 107 may hold the license plate information of the vehicle and the feature information of the appearance of the vehicle. The identification means 106 identifies the vehicle using these pieces of information, and superimposes the result of identification on the image.

### (Hardware Configuration)

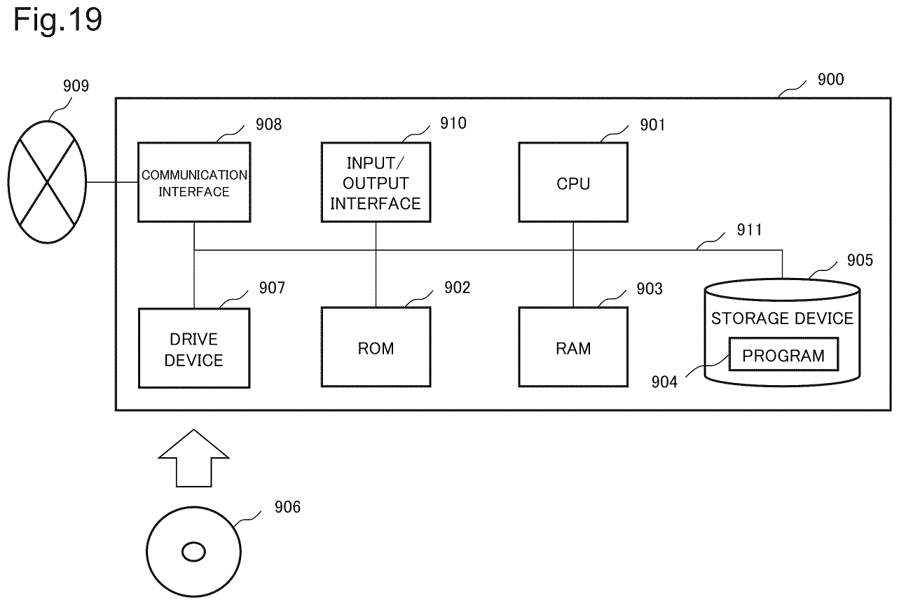

In each example embodiment of the present disclosure, each component of each device indicates a block of a functional unit. Part or all of each component of each device is achieved by, for example, an any combination of an information processing device 900 and a program as illustrated in FIG. 19. FIG. 19 is a block diagram illustrating an example of a hardware configuration of the information processing device 900 that achieves each component of each device. The information processing device 900 includes the following configuration as an example.
Central processing unit (CPU) 901
Read only memory (ROM) 902
Random access memory (RAM) 903
program 904 loaded into RAM 903
Storage device 905 storing program 904
Drive device 907 that reads and writes recording medium 906
Communication interface 908 connected with communication network 909
Input/output interface 910 for inputting/outputting data
Bus 911 connecting respective components

Each component of each device in respective example embodiments is achieved by the CPU 901 acquiring and executing the program 904 for achieving these functions. That is, the CPU 901 of FIG. 19 may execute a program for selecting the camera nearest to the target facility and acquiring an image or a program for transmitting an image to a predetermined terminal, and perform update processing of each calculation parameter held in the RAM 903, the storage device 905, or the like. The program 904 for achieving the function of each component of each device is stored in the storage device 905 or the ROM 902 in advance, for example, and is read by the CPU 901 as necessary. The program 904 may be supplied to the CPU 901 via the communication network 909, or the program 904 may be stored in advance in the recording medium 906 and the drive device 907 may read the program and supply the program to the CPU 901.

The program 904 can display the processing result including the intermediate state for each stage via the display device as necessary, or can communicate with the outside via the communication interface. The program 904 can be recorded on a computer-readable (non-transitory) storage medium.

There are various modifications of the method of achieving each device. For example, each device may be achieved by an any combination of the information processing device 900 and the program separate for each component. A plurality of components included in each device may be achieved by any combination of one information processing device 900 and a program. That is, each of the devices can be achieved by a computer program that causes a processor mounted in each of the devices described in the first to fifth example embodiments to execute each of the above-described processes using the hardware.

Part or all of each component of each device is achieved by another general-purpose or dedicated circuit, processor, or the like, or a combination thereof. These may be configured by a single chip or may be configured by a plurality of chips connected via a bus.

Part or all of the components of each device may be achieved by a combination of the above-described circuit and the like and a program.

In a case where part or all of each component of each device is achieved by a plurality of information processing devices, circuits, and the like, the plurality of information processing devices, circuits, and the like may be disposed in a centralized manner or in a distributed manner. For example, the information processing device, the circuit, and the like may be achieved as a form in which each is connected via a communication network, such as a client and server system or a cloud computing system.

Each of the above-described example embodiments is a preferred example embodiment of the present disclosure, and the scope of the present disclosure is not limited only to each of the above-described example embodiments. That is, it is possible for those of ordinary skill in the art to make modifications and substitutions of the above-described example embodiments without departing from the gist of the present disclosure, and to construct a mode in which various modifications are made.

The first to fifth example embodiments described above can be made into different example embodiments by combining the respective features. For example, by combining the search function of a suspicious person or the like of the first example embodiment and the third example embodiment, it is also possible to construct a security assistance system that searches for a suspicious person or a suspicious vehicle a predetermined time before the abnormality notification.

Some or all of the above example embodiments may be described as the following Supplementary Notes, but are not limited to the following.
[Supplementary Note 1]
   A security assistance system including
      a reception means for receiving an abnormality notification from a security system of a facility set as a security target,
      an acquisition means for selecting a camera disposed at a road nearest to the facility, and acquiring an image captured by the camera, and
      a transmission means for transmitting the acquired image to a predetermined terminal.
[Supplementary Note 2]
   The acquisition means of the security assistance system described above may be configured to select a camera having a high possibility of capturing an image of a person or a vehicle who has visited the facility based on a disposition of a camera around the facility, and acquire the image captured by the camera.
[Supplementary Note 3]
   The acquisition means of the security assistance system described above may be configured to estimate a traveling direction of the person or the vehicle based on the acquired image captured by the camera, and
      the acquisition means may be configured to further select a camera capable of capturing an area in the traveling direction, and acquire the image captured by the camera, and
      the transmission means may be configured to transmit a series of images acquired by the acquisition means.
[Supplementary Note 4]
   The acquisition means of the security assistance system described above may be configured to further acquire an image before the abnormality notification is received from an image recording device that stores the image captured by the camera for a certain period of time, and
      the transmission means may be configured to transmit the image before the abnormality notification is received to the predetermined terminal.
[Supplementary Note 5]
   The abnormality notification may include information indicating a type of an abnormality detected by the security system, and
      the acquisition means of the security assistance system described above may be configured to select the camera that acquires the image based on the type of the abnormality.
[Supplementary Note 6]
   In the security assistance system described above, when the type of the abnormality includes information indicating that an intrusion into the facility has occurred, the acquisition means may be configured to increase the number of cameras to be selected.
[Supplementary Note 7]
   In the security assistance system described above, when the type of the abnormality includes information indicating that a suspicious person or a suspicious vehicle staying around the facility is detected and position information about the suspicious person or the suspicious vehicle, the acquisition means may be configured to narrow down the camera to be selected to a camera around the suspicious person or the suspicious vehicle.
[Supplementary Note 8]
   The security assistance system described above may further include
      a storage means for storing feature data on appearance of a person or a vehicle set in advance for each facility as a security target, and
      an identification means for identifying the person or the vehicle appearing in the image captured by the camera based on the feature data, wherein
      the transmission means may be configured to transmit an image on which a result of identification by the identification means is superimposed to the predetermined terminal.
[Supplementary Note 9]
   A security assistance method including
      receiving an abnormality notification from a security system of a facility set as a security target,
      selecting a camera disposed at a road nearest to the facility, and acquiring an image captured by the camera, and
      transmitting the acquired image to a predetermined terminal.
[Supplementary Note 10]
   A recording medium recording a program for causing a computer to execute the steps of
      receiving an abnormality notification from a security system of a facility set as a security target,
      selecting a camera disposed at a road nearest to the facility, and acquiring an image captured by the camera, and
      transmitting the acquired image to a predetermined terminal.

The forms of the Supplementary Notes 9 to 10 can be expanded to the forms of the Supplementary Notes 2 to 8, as in the Supplementary Note 1.

The disclosure of the above PTL is incorporated herein by reference, and can be used as a basis or part of the present invention as necessary. Within the frame of the entire disclosure (including the claims) of the present invention, it is possible to change and adjust the example embodiments or examples further based on of the basic technical idea thereof. Various combinations or selections (including partial deletions) of various disclosure elements (respective elements of each claim, respective elements of each example embodiment or example, respective elements of each drawing, and the like are included) can be made within the frame of the disclosure of the present invention. That is, it goes without saying that the present invention includes various modifications and corrections that can be made by those of ordinary skill in the art in accordance with the entire disclosure including the claims and the technical idea. Specifically, for numerical ranges set forth herein, any numerical value or sub-range included within the range should be construed as being specifically described, even when not stated otherwise. Furthermore, it is also deemed that in the matters disclosed in the document cited above, using part or all of the matters disclosed in the document in combination with the matters described in the present specification as part of the disclosure of the present invention according to the gist of the present invention as necessary is included in the matters disclosed in the present application.

### REFERENCE SIGNS LIST

100, 100a to 100e security assistance system
101 reception means
102, 102b, 102d acquisition means
103 transmission means
104 camera disposition storage means
200, 200 terminal
300 security system
400, C001 to C004 camera
500 image recording device
900 information processing device
901 central processing unit (CPU)
902 read only memory (ROM)
903 random access memory (RAM)
904 program
905 storage device
906 recording medium
907 drive device
908 communication interface
909 communication network
910 input/output interface
911 bus
1021 tracking means
RD road
TF facility
SU suspicious person

What is claimed is:

1. A security assistance system comprising:
a memory configured to store instructions; and
one or more processors configured to execute the instructions to:
receive an abnormality notification from a security system of a facility set as a security target;
select a camera disposed at a road nearest to the facility;
acquire an image captured by the camera; and
transmit the acquired image to a predetermined terminal.

2. The security assistance system according to claim 1, wherein
the one or more processors are further configured to execute the instructions to:
select a camera having a high possibility of capturing an image of a person or a vehicle who has visited the facility based on a disposition of a camera around the facility; and
acquire the image captured by the camera.

3. The security assistance system according to claim 2, wherein
the one or more processors are further configured to execute the instructions to:
estimate a traveling direction of the person or the vehicle based on the acquired image captured by the camera;
select a camera capable of capturing an area in the traveling direction;
acquire the image captured by the camera; and
transmit a series of acquired images.

4. The security assistance system according to claim 1, wherein
the one or more processors are further configured to execute the instructions to:
acquire an image before the abnormality notification is received from an image recording device that stores the image captured by the camera for a certain period of time; and
transmit the image before the abnormality notification is received to the predetermined terminal.

5. The security assistance system according to claim 1, wherein
the abnormality notification includes information indicating a type of an abnormality detected by the security system, and wherein
the one or more processors are further configured to execute the instructions to:
select the camera that acquires the image based on the type of the abnormality.

6. The security assistance system according to claim 5, wherein
the one or more processors are further configured to execute the instructions to:
when the type of the abnormality includes information indicating that an intrusion into the facility has occurred, increase the number of cameras to be selected.

7. The security assistance system according to claim 5, wherein
the one or more processors are further configured to execute the instructions to:
when the type of the abnormality includes information indicating that a suspicious person or a suspicious vehicle staying around the facility is detected and position information about the suspicious person or the suspicious vehicle, narrow down the camera to be selected to a camera around the suspicious person or the suspicious vehicle.

8. The security assistance system according to claim 1, wherein
the one or more processors are further configured to execute the instructions to:
store feature data on appearance of a person or a vehicle set in advance for each facility as a security target;
identify the person or the vehicle appearing in the image captured by the camera based on the feature data; and
transmit an image on which a result of identification is superimposed to the predetermined terminal.

9. A security assistance method comprising:
receiving an abnormality notification from a security system of a facility set as a security target;
selecting a camera disposed at a road nearest to the facility, and acquiring an image captured by the camera; and
transmitting the acquired image to a predetermined terminal.

10. A non-transitory computer-readable recording medium recording a program for causing a computer to execute the steps of:
receiving an abnormality notification from a security system of a facility set as a security target;
selecting a camera disposed at a road nearest to the facility, and acquiring an image captured by the camera; and
transmitting the acquired image to a predetermined terminal.
